(19) United States
(12) Patent Application Publication
(10) Pub. No.: US 2004/0133491 A1
(43) Pub. Date: Jul. 8, 2004

(54) Method for recapitalization of debit by companies under financial stress

(76) Inventor: Thomas N. Cochran, Far Hills, NJ (US)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/338,748

(22) Filed: Jan. 8, 2003

(51) Int. Cl. G06F 17/60

(52) U.S. Cl. 705/35

(57) ABSTRACT

Methods of recapitalizing a corporation or nation's obligations including reorganizing the principal owed on maturity and interest rate and period of a single class of Base Security and creating a Companion Security or an option. In one method, the Companion Security or option offers an increased payment of income and a decreased principal owed on maturity when compared to the Base Security. The holders of the Base Security are then offered the right to exchange the Base Security for the Companion Security or option, thereby terminating the corporation's obligations. Alternatively, a call option is offered from a holder of the Base Security to the corporation where the corporation has the right to repurchase the Base Security at less than the principal originally owed at maturity with the right to specify a different time than the original maturity or an agreement to make future payments tracking the interest payment period of the Base Security.

### FIELD OF THE INVENTION

The present invention relates to methods of voluntary or mandatory recapitalization of financial obligations of corporations or nations that are, or that are believed to be, at risk of insolvency.

### BACKGROUND OF THE INVENTION

In the natural life cycle of a corporation, a corporation will generally, at some time, issue debt obligations and/or preferred stock for the purpose of raising capital. As business conditions change, such a corporation, which was once viewed as capable of repaying those obligations, may come to be viewed by the market as vulnerable to collapse.

In such circumstances, its securities will fall sharply in price, often to a fraction of their original issue prices. When the present market prices are so low, it is apparent that those holding the interest (or dividend) paying securities attach only a nominal value to the return of the principal at the value and at time originally specified. In such a case, almost all of the value of the security is concentrated in the interest or dividend payments due in the next few months or years. Technically, these market conditions are reflected in a “current yield” several times that of securities issued by corporations seen as strong. Also of significance is “yield to maturity”. “Yield to maturity,” a calculation that assumes receipt of payment on the maturity date as well as all of the intervening interest payments on scheduled interim dates, is also far above the norm, reflecting doubt the company will be able to retire the securities on schedule, or indeed at any time.

### SUMMARY OF THE INVENTION

It is an object of the present invention to provide methods of restructuring a corporation's obligations with the agreement of holders of some, but not necessarily all, of the relevant securities.

It is another object of this invention to preserve the corporation and the jobs, medical insurance, and pensions it provides, as an alternative to an agreed-upon negotiated bankruptcy or a conventional bankruptcy that will extinguish some or all of these factors.

It is a further object of the present invention to improve the market prospects, and indeed the current prices, of all a corporation's securities, whether or not exchanged under or subject to an offer that might affect them, and including the common stock, because the corporation's shareholder equity and its chance of survival are improved, and its prospects after survival are improved.

It is still a further object of the present invention to provide better short-term returns for the holders of securities restructured, as their income return—the one factor receiving significant weight in the market for dramatically depressed income securities—is materially increased.

It is also an object of the present invention to provide significant expense savings over the usual alternative of bankruptcy.

It is yet a further object of the present invention that important savings of time be realized in accomplishing the corporate rescue, a major advantage in today's fast-changing business world when compared to the usual delays and the resulting loss of experienced people that often accompany bankruptcy.

To achieve these objectives the invention provides a method of recapitalization of a corporation's obligations or a nation's obligations comprising the steps of reorganizing the principal owed on maturity and interest rate and period of a single class of Base Security; creating a Companion Security or an option wherein, when compared to the Base Security, the Companion Security or option offers an increased payment of income and a decreased principal owed on maturity; and offering the holders of the Base Security the right to exchange the Base Security for the Companion Security or option, thereby terminating the corporation's obligations under the Base Security and obligating the corporation under the Companion Security or option.

The Companion Security and the Base Security can have the same maturity date and same period of interest payment. Alternatively, the Companion Security and the Base Security can have a different maturity date and a different period of interest payment.

The invention provides another method of recapitalization of a corporation's obligations or a nation's obligations comprising the steps of reorganizing the principal owed on maturity and interest rate and period of a single class of Base Security; and offering a call option from a holder of the Base Security to the corporation wherein the corporation would have the right to repurchase the Base Security at less than the principal originally owed at maturity with the additional right to specify a different time than the original maturity or the corporation would have an agreement to make future payments tracking the interest payment period of the Base Security.

The invention provides yet another method of recapitalization of a corporation's obligations or a nation's obligations comprising the steps of reorganizing the principal owed on maturity and interest rate and period of a single class of Base Security; and providing a put option to a holder of the Base Security wherein the holder of the put option has the right to require the corporation to repurchase the Base Security at a date and for a value, wherein at least one of the date and the value may differ from the original terms of the Base Security.

### DETAILED DESCRIPTION OF THE INVENTION

### EXAMPLE 1

Assume a steel or textile company, founded a century ago and having provided employment for generations in its community, is today operating with negligible profits under the pressure of foreign and domestic competitors. Two decades ago, when the industry and the company were experiencing better times, $100 million of bonds were sold at “par,” which is quoted as 100 in the market but actually is shorthand for a price of $1,000 per bond (“Base Security” of bond at its original maturity value). In the stated example, each bond bore a conventional coupon providing a 7%, or $70, annual yield, payable as $35 every six months. Those bonds will mature five years from now. It should be noted that although the example discusses bonds at its original maturity value, the term “Base Security” as disclosed herein is also intended to cover the stated value of preferred stock.

As the company's fortunes have deteriorated, the market's judgment is that payment of bond principal at maturity is most unlikely, and indeed many observers doubt the $70 annual yield can long be maintained. The bonds have fallen from a quote of 100 some years ago to 10 ($100 per bond) today. At that price, it is clear that minimal, if any, value is attributed to payment of principal at maturity. In fact, bond holders are willing to sell to speculative buyers at 10, a price affording buyers a profit if only the next three payments of coupon are made. If the next four semi-annual payments are made, the total return would be $140 on a $100 investment—and the buyer would still own the bonds. Such prices may seem exaggeratedly low, but in fact still lower valuations are regularly seen for the securities of companies whose future is believed doubtful.

Bankruptcy would usually be viewed as the next likely step, but management of the company believes the enterprise can be rescued—or can at least improve its chance of survival—through use of the subject patent. This is accomplished by issuance of a Companion Security with the new terms for maturity value and income payments. For example, Management offers to double the bond coupon, paying $140 annually on each bond, if bondholders will accept $500 at maturity, half the originally scheduled amount.

Bond owners, who by now care little about payment at maturity, will be likely to accept the offer. Every bond accepting the offer receives twice as much of the only factor now valued by the market: current income. The company may hold the exchange offer open indefinitely. Present bond owners who do not accept the offer will find the bond price moves substantially higher, as traders buy the bonds and elect the exchange.

On the company's balance sheet, the acceptance of each exchange of a bond reduces liability by $500, and the total liability reduction could reach $50 million on the $100 million of initial value. Over the next five years, the extra interest paid would be $350 per bond exchanged, but that is still an improvement over paying full face value of the bonds at maturity.

Meanwhile, the improved balance sheet gives some encouragement to trade creditors and banks. Moreover, the better chance of long-term survival, and the probable postponement—at the least—of the need for bankruptcy, work to the benefit of all the corporation's securities, even those not subject to the exchange offer, and including the depressed common stock.

### EXAMPLE 2

Assuming a company in the same condition as in Example 1, an alternate procedure could involve the same general terms for bond exchange except for a schedule of rising interest payments. The next coupon could be set at $50 (instead of $35 being doubled at once to $70), the second at $60, and the third and later payments at the same $70 as seen in Example 1. Alternatively, the scheduled payments could start at $70, but with the later payments decreasing; creditors and others not owning the bonds but with an economic interest in the company's survival might find the restructuring more acceptable in this form. Still further, the last bond coupon—normally paid at maturity—could be eliminated, in return for slightly earlier repayment of principal on the bonds than was originally scheduled. That earlier payment would also act as an incentive to accept the new bond terms. The newer bonds would be slightly more likely to be repaid at new maturity, ahead in time of the maturity date on the present bonds.

### EXAMPLE 3

The restructuring of Example 1 or Example 2 could be accomplished through the use of options, rather than by exchange of bonds. This alternative might well be faster to implement because it would not require a formal offer of exchange or a substitution of new bonds for existing bonds. In the example, the holder of a bond would sell a call option to the issuing company, so the company would have the right to repurchase that bond for $500 at its possibly different maturity date, or at an earlier date than originally or later scheduled. The company, should the restructuring succeed early, would wish to call in the bonds early because of their high interest cost. The ability to make early call will act to reassure creditors and others not holding the restructured bonds. And it will be remembered that those who do presently hold the target bonds have little expectation of payment at any maturity under current conditions, so that earlier repayment (and receipt of less income) is of little concern to them. In Example 3, a participating bond holder would receive payment for the call option as suggested in Examples 1 and 2, except that the regular coupon would continue to be paid as before, with additional amounts to be received by those who sold calls. Those additional amounts might be payable on the same due dates as were originally scheduled for the bond coupons or preferred stock dividends; in this case, option payment takes place over time. In addition to the promise of more cash, call option sellers would receive a put option—an option they could exercise on the presently scheduled maturity date or at a specified different date, as mentioned above. The put option makes an earlier maturity date simple to achieve for the affected bonds, without requiring exchange of new bonds for old. It is anticipated that both the puts and calls would be freely tradeable on the financial markets, separately from each other and from the bonds. Freely tradeable options, plus separately freely tradeable bonds, are highly likely to have more aggregate value than restructured bonds alone, or restructured bonds with untraded or non-separable options.

What is claimed is:

1. A method of recapitalization of one of a corporation's obligations and a nation's obligations comprising the steps of:
reorganizing the principal owed on maturity and interest rate and period of a single class of Base Security;
creating one of a Companion Security and an option wherein, when compared to said Base Security, one of said Companion Security and option offers an increased payment of income and a decreased principal owed on maturity; and
offering the holders of said Base Security the right to exchange said Base Security for one of said Companion Security and option, thereby terminating said corporation's obligations under said Base Security and obligating said corporation under one of said Companion Security and option.

2. The method of claim 1, wherein said Companion Security and said Base Security have a same maturity date and a same period of interest payment.

3. The method of claim 1, wherein said Companion Security and said Base Security have a different maturity date and a different period of interest payment.

4. A method of recapitalization of one of a corporation's obligations and nation's obligations comprising the steps of:
reorganizing the principal owed on maturity and interest rate and period of a single class of Base Security; and
offering a call option from a holder of said Base Security to the corporation wherein the corporation would have the right to repurchase said Base Security at less than the principal originally owed at maturity with the additional right to specify a different time than the original maturity.

5. A method of recapitalization of one of a corporation's obligations and nation's obligations comprising the steps of:
reorganizing the principal owed on maturity and interest rate and period of a single class of Base Security; and
offering a call option from a holder of said Base Security to the corporation wherein the corporation would have an agreement to make future payments tracking the interest payment period of said Base Security.

6. A method of recapitalization of one of a corporation's obligations and nation's obligations comprising the steps of:
reorganizing the principal owed on maturity and interest rate and period of a single class of Base Security; and
providing a put option to a holder of said Base Security wherein the holder of said put option has the right to require the corporation to repurchase said Base Security at a date and for a value, wherein at least one of the date and the value may differ from the original terms of said Base Security.
